(19) United States
(12) Patent Application Publication
(10) Pub. No.: US 2004/0224575 A1
(43) Pub. Date: Nov. 11, 2004

(54) LOW INSERTION FORCE ELECTRICAL SOCKET CONTACT

(76) Inventors: CRAIG H. BAKER, SHREWSBURY, MA (US); CLYDE T. CARTER, SHERMANS DALE, PA (US); ALEXANDER S. FATER, WORCESTER, MA (US); URS F. NAGER, HUDSON, NH (US); CHRISTOPHER P. PALAGI, UPTON, MA (US); CHRISTINE MARY SVELNIS, BOYSLTON, MA (US); MARK A. WOJCICKI, HOLDEN, MA (US)

Correspondence Address: GUNNER G. LEINBERG, ESQ., NIXON PEABODY LLP, CLINTON SQUARE, P.O. BOX 31051, ROCHESTER, NY, 14603, US

(21) Appl. No.: 09/374,681

(22) Filed: Sep. 19, 2002

(51) Int. Cl. H01R 12/00

(52) U.S. Cl. 439/884

(57) ABSTRACT

A low insertion force electrical socket contact has a plurality of inwardly extending projections that function as arc receiving elements upon the initial mating of the socket contact with a corresponding male pin contact. The spacing of the inwardly extending arc receiving elements is such that the maximum transverse distance therebetween across the socket contact bore is greater than the maximum transverse distance of the male pin contact. Further insertion mating of the male pin contact establishes electrical contact with a plurality of integrally formed spring contacts in the socket contact.

### BACKGROUND OF THE INVENTION

The present invention relates to electrical contacts in general, and more particularly to an electrical female socket contact that mates with a male pin contact to provide a sacrificial make-first/break-last contact arrangement for use in a “hot pluggable” electrical contact configuration.

There is a need for electrical contacts that can be connected and disconnected under an electrical load i.e., “hot pluggable” and at the same time have the capability of accommodating axial misalignment of pin and socket electrical contacts. Furthermore, the socket contact should be able to provide arc receiving “sacrificial” portions to maintain electrical integrity of the fully mated pin and socket contacts while at the same time being able to mate with a low insertion force.

It is accordingly a general object of the invention to fulfill this need.

### BRIEF DESCRIPTION OF THE INVENTION

A low insertion force electrical socket contact employs a plurality of inwardly extending projections that function as arc receiving elements upon the initial mating of the socket contact with a corresponding male pin contact. The distance between the inwardly extending arc receiving elements measured across the socket contact bore is greater than the maximum transverse distance of the male pin contact. Further insertion mating of the male pin contact establishes electrical contact with a plurality of integrally formed spring contacts in the socket contact.

### BRIEF DESCRIPTION OF THE DRAWINGS

FIG. 1 is an isometric view of the socket contact of the present invention;

FIG. 2 is a side elevation of the socket contact of FIG. 1;

FIG. 3 is an end view of the socket contact of FIG. 2;

FIG. 4 is a plan view of the socket of FIG. 2; and,

FIG. 5 is a view in cross-section taken along line A-A of FIG. 2.

### DETAILED DESCRIPTION

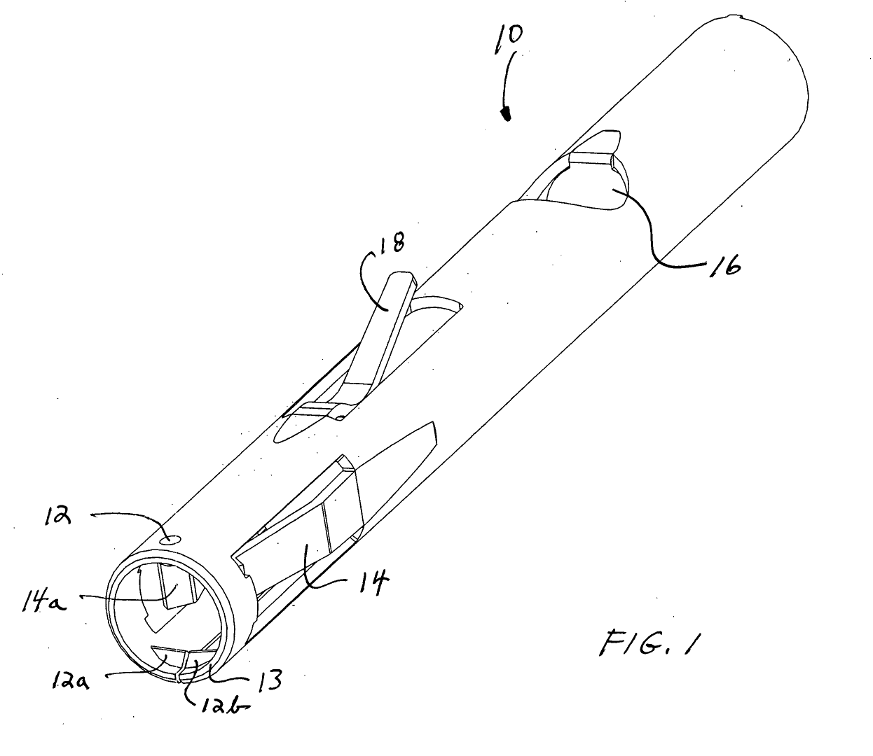

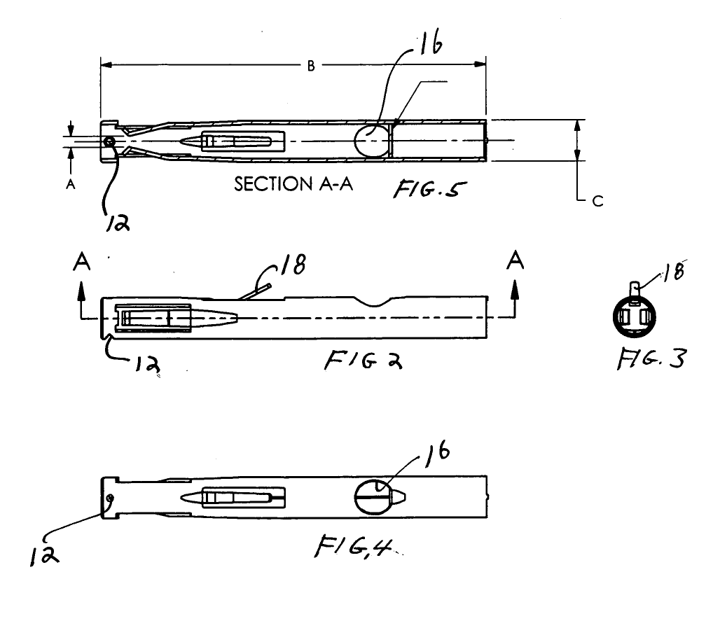

Turning now to the drawings, and particularly to FIG. 1, there is shown an electrical socket contact indicated generally by the reference numeral 10. The socket contact 10 preferably is stamped and rolled into the configuration shown in FIG. 1 from a single sheet of material. The socket contact 10 has at least two inwardly projecting arc receiving elements 12 (one of which is shown in split form as 12a and 12b in FIG. 1 because of the preferred stamped and rolled socket contact embodiment). It should be noted that the inwardly extending arc receiving elements 12 can take the form of an inwardly extending stamped “dimple” as shown in FIGS. 2, 4 and 5. The arc receiving elements 12 typically establish an initial electrical contact with a corresponding male pin contact (not shown and depending upon mis-alignment of the male pin contact with the socket contact 10) and a subsequent last contact upon mating withdrawal (“make first/break-last”). The arc receiving elements 12 are spaced apart across the bore axis of the socket contact at a maximum distance that is greater than the maximum transverse distance of the male pin contact. This spacial configuration permits the initial contact mating of the arc receiving elements 12 to function as “sacrificial” elements while the fully mated male/female electrical contact is established by a plurality of integrally formed spring contacts 14 which thus maintain their electrical and physical integrity. It should be noted that the forward portions 14a of the spring contacts 14 cooperate with arc receiving elements 12, and the forward end 13 of the socket barrel itself to provide a “triple” arc receiving entrance for the male pin contact (not shown). Assuming enought axial mis-alignment, this would take place sequentially, as the socket contact ring 13, the arc receiving projections 12 and the forward end of the cantilevered beams 14 (see FIGS. 2-5)

Preferably, the socket contact 10 has an opening 16 to its bore that provides a “solder pot” for soldering an electrical cable (not shown) to the contact. In addition to providing a “solder pot”, the opening 16 also furnishes a gas pressure relief during the solder operation. It will be appreciated that if the socket contact 10 is used as a “crimp” contact for an electrical cable, opening 16 limits the travel distance of crimp deformation.

In addition to the optional “solder pot” opening 16, the socket contact 10 has an optional spring housing latch 18 for removable insertion into a contact housing (not shown) in a conventional manner.

Having described in detail a preferred embodiment of our invention, it will be apparent to those in the art that numerous modifications can be made therein without departing from the scope of the invention as defined in the following claims.

What we claim is:

1. An electrical socket contact for mating with a pin contact comprising:
an electrically conductive body having a pin contact engaging bore, the body comprising:
at least two pin contact arc receiving elements which extend in to the bore, wherein the arc receiving elements are spaced apart across the bore a distance that is greater than a maximum transverse dimension of the pin contact; and
a plurality of spring contacts spaced in from the arc receiving elements along the bore.

2. The electrical socket contact of claim 1 further having an aperture in the body.

3. The electrical socket contact of claim 1 wherein said arc receiving elements comprise stamped inwardly extending projections.

4. The electrical socket contact of claim 1 wherein said socket contact is form from a single sheet of material.

5. The electrical socket contact of claim 1 wherein engagement with said pin contact mating takes place in the sequence of:
contact with the socket contact itself, then the arc receiving elements and then the spring contacts.

6. The electrical socket contact of claim 1 further comprising a latch spaced in from the spring contacts along the bore.

7. The electrical socket contact of claim 1 wherein the arc receiving elements are fixed, non-cantilevered, arc receiving elements.

8. A method for making an electrical socket contact, the method comprising:
providing an electrically conductive body with a pin contact engaging bore;
providing at least two arc receiving elements in the body which extend into the bore, wherein the arc receiving elements are spaced apart across the bore a distance that is greater than a maximum transverse dimension of the pin contact; and
providing a plurality of spring contacts in the body which extend into the bore, the spring contacts are spaced in from the pin contact arc receiving elements along the bore.

9. The method of claim 8 further comprising providing at least one aperture in the body which extends through to the bore, the aperture is spaced in from the spring contacts along the bore.

10. The method of claim 8 wherein providing at least two pin contact arc receiving elements further comprising stamping a wall of the body to form the arc receiving elements.

11. The method of claim 8 wherein providing an electrically conductive body further comprises forming the electrically conductive body with a pin contact engaging bore from a single sheet of material.

12. The method of claim 8 further comprising providing a latch spaced in from the spring contacts along the bore.

13. The method of claim 8 wherein the arc receiving elements are fixed, non-cantilevered, arc receiving elements.

14. A method of mating an electrical socket contact with a pin contact, the method comprising:
coupling at least one arc receiving element in a bore in an electrically conductive body with the pin contact, wherein the pin contact arc receiving elements are spaced apart across the bore a distance that is greater than a maximum transverse dimension of the pin contact; and
contacting at least one spring contact in the bore in the body with the pin contact, the spring contact is spaced in from the pin contact arc receiving element along the axial bore.

15. The method of claim 14 further comprising exposing the pin contact in at least one aperture in the body which extends through to the bore, the aperture is spaced in from the spring contacts along the bore.

16. The method of claim 14 further comprising latching the pin contact with a latch which is spaced in from the spring contacts along the bore.

17. The method of claim 14 wherein the arc receiving element is a fixed, non-cantilevered, arc receiving element.
